(19) United States
(12) Patent Application Publication
(10) Pub. No.: US 2010/0289903 A1
(43) Pub. Date: Nov. 18, 2010

(54) Portable presentation computer station

(76) Inventor: Fitzroy Farquharson, Winter Garden, FL (US)

Correspondence Address: William M. Hobby, III, 157 E. New England Avenue, #375, Winter Park, FL, 32789, US

(21) Appl. No.: 12/454,009

(22) Filed: May 12, 2009

(51) Int. Cl. H04N 5/225

(52) U.S. Cl. 348/207.1; 348/E05.024

(57) ABSTRACT

A portable presentation computer station apparatus provides for the capture and modification of a presentation for display, storage and transmission to a remote computer. A laptop computer is combined with a video and still camera on a universal support arm and a writing tablet for capturing and combining elements of a presentation.

### BACKGROUND OF THE INVENTION

The present invention relates to a portable presentation computer station which can capture a presentation lecture being given by an individual while incorporating material written on a writing tablet. The presentation can then be stored on the computer or displayed on a screen or on individual computers connected through the internet.

In the past, it has been common to make presentations to an audience with the aid of an overhead projector. These projectors typically have a plate which is illuminated so that light passing through or to one side of an object is projected upward and then laterally onto a viewing screen. In one type of presentation, the presenter lays a series of clear or translucent plastic sheets on a projection plate one at a time while giving a talk. The sheets can contain written information, drawings, graphs, photographs, or any other type of visual information. Sometimes a presenter may write on the sheets as part of the presentation. In another type of presentation, an active matrix liquid screen is placed on the projection plate. The screen is connected to a personal computer which then sends signals to the screen to activate pixels of the liquid crystal screen to display computer generated images.

The Bogomolnyi U.S. Pat. No. 6,550,922 is for a system for making an audio-video recording of an overhead projector based presentation. It captures the audio-video recording of an overhead projector based presentation.

It has also been common in the past to provide writing tablets which are hand-writing data entry panels for capturing hand writing or drawing thereon directly into a computer. These writing tablets typically have pressure sensitive tablets and a touch pen connected to capture into a computer anything that is written on the tablet. Such systems can be seen in the Akiyama et al. U.S. Pat. No. 6,018,336 and in the Oka U.S. Pat. No. 5,835,081.

Samsung Techwin Co., Ltd. has a presentation station which includes a document camera and a PC in one device. The Samsung video presenter is a camera system which is designed for grabbing images of different kinds of objects which are placed under the camera. The camera can also be tilted and moved for grabbing different types of images from different angles. This presentation system is especially adapted for replacing overhead projectors, slide projectors and video document cameras for creating slides or overhead foils.

The present invention on the other hand is directed towards capturing a presenter's entire presentation, such as a lecturer giving a presentation in front of a blackboard, which presentation can include video still camera images and audio and which can also take video or still images of objects placed on the laptop computer as well as flip charts and other materials used in a presentation. The presentation station includes a keyboard for inputting from the keyboard as well as a built-in writing tablet that allows writings or drawings to be placed on top of presentation images. The presentation can then be presented on a large monitor or screen or can be saved and transmitted to individual computer users over the internet.

### SUMMARY OF THE INVENTION

A portable presentation computer station is provided in which a laptop computer has a computer screen, a keyboard, a mouse, and a mouse pen combined with a writing tablet operatively attached to the computer. A telescoping arm is movably attached to the computer with a video and still camera movably attached thereto. The telescoping arm has two ends with a hinged joint between the ends. The arm telescopes on both sides of the hinge allowing the telescoping arm to be folded into position adjacent the computer for storage and transportability. The video camera is movably attached to the end of the telescoping arm and operatively connected to the computer to thereby allow the video camera to be universally positioned over the writing tablet or directed for capturing a presentation. The portable presentation station can be set up to capture a presentation for display storage and transmission as desired. The writing tablet is positioned on the computer over the keyboard. The keyboard can be extended from underneath the writing tablet. In addition, the video and still camera has an audio mike therein as well as camera lights for capturing the image or writing on the writing tablet as well as an entire presentation. The laptop computer has a built-in camera which can be used for capturing images for incorporating into the presentation. The telescoping arm has a rotating joint connecting the arm to the laptop computer for rotating the camera mounted thereto. The portable presentation computer station also has a case attached to the computer and positioned for the telescoping arm to fold into for storage and transportability while remaining operatively connected to the laptop computer. The case can have a generally U-shaped cross-section for the telescoping arm to fold into for storage and transportability. The computer has a remote control for actuating the computer and video camera.

### BRIEF DESCRIPTION OF THE DRAWINGS

Other objects, features, and advantages of the present invention will be apparent from the written description and the drawings in which:

FIG. 1 is a perspective view of a portable presentation computer station in accordance with the present invention;

FIG. 2 is a perspective view of the camera head of the presentation station of FIG. 1;

FIG. 3 is an elevation view of the camera head;

FIG. 4 is a top elevation of the presentation station positioned for capturing objects placed on the computer writing tablet;

FIG. 5 is a top elevation of the computer presentation station with the telescoping arm folded for transporting the unit; and

FIG. 6 is a perspective view of the presentation station of FIG. 1 capturing a presentation.

### DETAILED DESCRIPTION OF THE PREFERRED EMBODIMENT

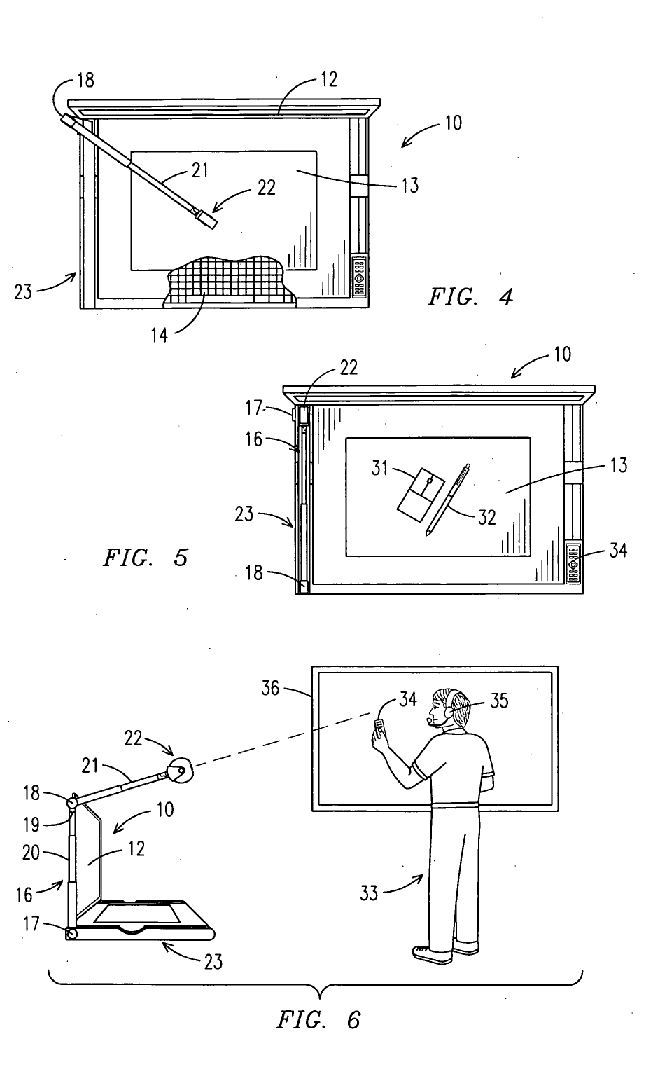

Referring to the drawings and to FIG. 1, a portable presentation computer station 10 includes a laptop computer 11, having a computer screen 12 and having a writing tablet 13 on the top over a slide-out keyboard 14. The computer 11 has a built-in camera 15 which can take still or video images which are captured in the computer and held in the memory of the computer. The presentation station 10 includes a telescoping arm 16 attached to the laptop computer 11 with a rotary joint 17. The telescoping arm 16 is hinged with a hinge 18 and has a telescoping portion 20 and a telescoping portion 21. The hinge 18 also has a pinned rotating section 19 which allows the arm portion 21 to rotate on the arm portion 20. This allows the arm portion 21 and camera 22 to swing over the writing tablet as seen in FIG. 4. The telescoping portion 20 is movably attached with a joint 17 to the laptop computer 11. The telescoping arm 21 has a camera 22 mounted on the end thereof for capturing still or video images and also has a microphone mounted therein as well as camera lights. The telescoping arm 20 rotates on the hinged joint 17. The telescoping arm 21 is mounted with the hinge 18 to the telescoping portion 20 to allow the entire arm 16 to be folded and positioned in a carrying case 23. The arm can be folded into the case 23 and the computer screen 12 folded for portability of the presentation unit 10.

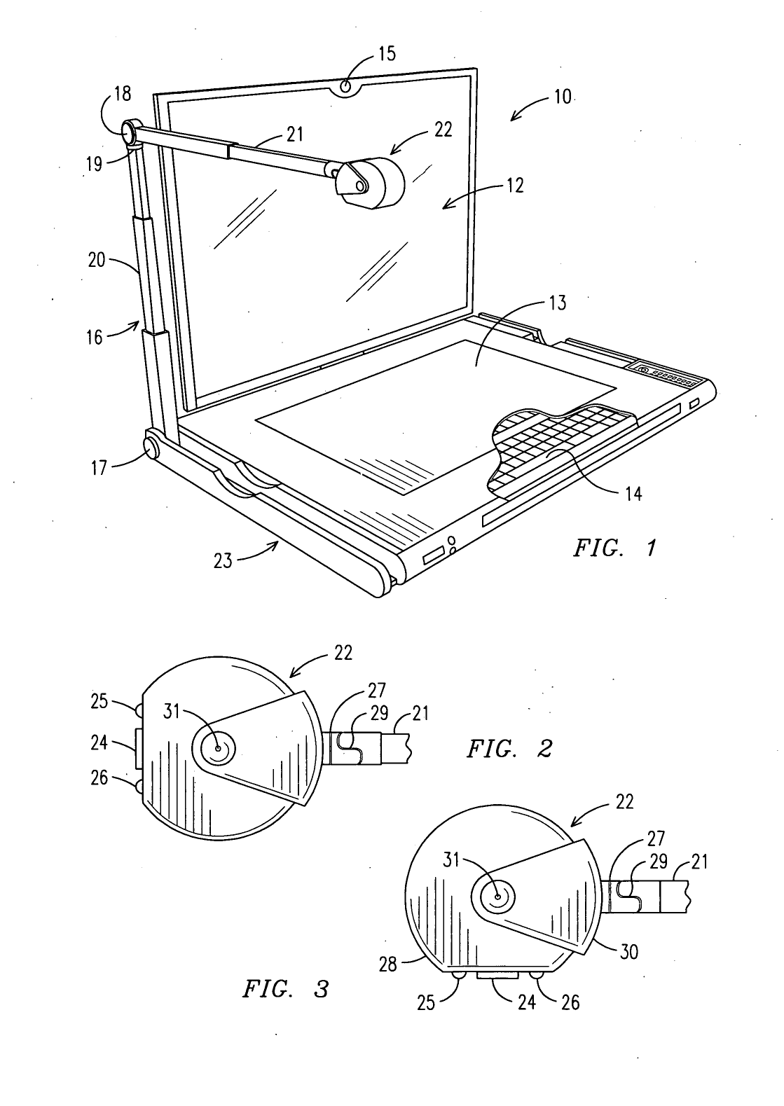

As more clearly seen in FIGS. 2 and 3, the camera head 22 has a camera lens 24 along with a camera light 25 placed on one side and also has a microphone 26 mounted therein. The camera head 22 can be seen as mounted on a rotary joint 27 at the end of telescoping arm portion 21. The camera system 22 has a rotary casing 28 mounted in a yoke 30 for rotation on a shaft 31 which allows the camera 22 to be repositioned to change the face of the camera lens 24 from a horizontal position in FIG. 2 to a vertical position of FIG. 3. This also allows the camera lens to be rotated 180 degrees to invert the image. The camera can also be rotated on the rotary joint 27 as well as on the joint 29 to thereby allow a universal positioning of the camera lens 24. The joint 29 allows the camera lens to remain horizontal while aligning the lens over the writing table 13. Electrical connectors lead from the computer to the camera and lights through the arm 21 for transmitting power to the camera and lights and for transmitting images captured by the camera head 22 to the laptop computer.

As more clearly seen in FIGS. 4 and 5, the presentation station 10 has a writing tablet 13 mounted on a base thereof and has a keyboard 14 mounted beneath the writing tablet which can be pulled out from underneath the writing tablet in order to use the keyboard. The writing tablet 13 is also used for a surface for placing objects that are being photographed with the camera head 22 by telescoping and rotating the telescoping arm 16 to position the camera over the writing tablet as shown in FIG. 4. The presentation station of the present invention also comes with a wireless mouse 31 and a mouse pen 32.

Turning to FIG. 6, a person 33 making a presentation before a blackboard 36 is shown placed with the camera 22 facing the presentation being made and with the presentation unit being placed on a table nearby. The presenter has a remote control 34 which allows for the starting and stopping of the camera recording and also has a blue-tooth earpiece and mike 35 which can be used to directly capture the voice from the presenter into the computer. Once the images are captured in the laptop computer 11 memory, they can be outputted from the computer to a video projector for projecting the presentation onto a screen output or can be transmitted over the internet to an output display. The presentation, for example, can be transmitted to a personal computer for display on the personal computer screen. The captured presentation can also be manipulated within the computer by editing the captured video and with the addition of additional images or materials as desired including still images for the camera 22 or hand writing or drawings made on the writing tablet 13.

It should be clear at this point that a computer presentation station has been provided which it adapted to capture a presentation for display, storage and transmission. However, the present invention is not to be construed as limited to the forms shown which are to be considered illustrative rather than restrictive.

I claim:

1. A portable presentation computer station comprising:
a laptop computer having a computer screen, a keyboard, a mouse and mouse pen;
a writing tablet operatively attached to said computer;
a telescoping arm having two end portions and having one end portion attached to said computer, said telescoping arm having a hinged joint between the end portions thereof allowing said telescoping arm to be folded into a position adjacent said computer for storage and transportability; and
a video camera movably attached to the other end portion of said telescoping arm and operatively connected to said computer thereby allowing said video camera to be universally positioned over said writing tablet or directed for capturing a presentation;
whereby a portable presentation station can be set up to capture a presentation for display, storage and transmission.

2. The portable presentation computer station in accordance with claim 1 in which said writing tablet is positioned over said keyboard.

3. The portable presentation computer station in accordance with claim 2 in which said video camera has an audio-mike therein.

4. The portable presentation computer station in accordance with claim 3 in which said keyboard is slidable mounted to said computer from under said writing tablet.

5. The portable presentation computer station in accordance with claim 4 in which said telescoping arm telescopes on both sides of said hinged joint.

6. The portable presentation computer station in accordance with claim 5 in which said telescoping arm has a rotating joint therein.

7. The portable presentation computer station in accordance with claim 6 in which said telescoping arm has a pair of rotating joints therein, one on each side of said hinged joint.

8. The portable presentation computer station in accordance with claim 7 in which said telescoping arm is rotatably attached to said computer.

9. The portable presentation computer station in accordance with claim 8 including a case attached to said computer and positioned for said telescoping arm to fold into for storage and transportability.

10. The portable presentation computer station in accordance with claim 9 in which said case has a generally U-shaped cross-section for said telescoping arm to fold into for storage and transportability.

11. The portable presentation computer station in accordance with claim 10 in which said computer has a remote control for actuating said computer and video camera.

12. The portable presentation computer station in accordance with claim 11 including a camera light mounted adjacent said video camera.
